(19) United States
(12) Patent Application Publication
(10) Pub. No.: US 2016/0064909 A1
(43) Pub. Date: Mar. 3, 2016

(54) SUPPORT PLATE FOR MOUNTING A GANGBOX SIDEWAYS

(71) Applicant: Robert Katsnelson, Staten Island, NY (US)

(72) Inventor: Robert Katsnelson, Staten Island, NY (US)

(21) Appl. No.: 14/470,086

(22) Filed: Aug. 27, 2014

(51) Int. Cl. H02G 3/08; H02G 3/10

(52) U.S. Cl. CPC H02G 3/085; H02G 3/08; H02G 3/10

(57) ABSTRACT

Disclosed is a support plate for mounting a side of an electrical gangbox to a wall stud wherein, he gangbox comprises at least one circular knockout disposed on a side thereof. The support plate comprises at least one elongate, oblique fastener hole, each of which adapted to receive a fastener therethrough. As the rear surface of the support plate is engaged with the inner side surface of the gangbox such that, the egress or egresses of the at least one fastener hole is disposed to be within the areal purview of the at least one knockout hole, a fastener thoroughly received within a fastener hole is adapted to engage the support member through a knockout hole. Notably, a knockout hole comprises the hole formed by the removal of a knockout.

### BACKGROUND

### Field of the Invention

The present invention relates to electrical accessories and more particularly to a support plate for mounting an electrical gangbox to a wall stud or a similar support member sideways.

Widely known in the art, an electrical gangbox comprises a simple open rectangular box made of metal or plastic adapted to be installed within a wall for receiving electrical componentry therewithin that is required for supporting electrical switches, sockets, etc. A gangbox further comprises a plurality of knockouts for receiving wiring and the like therethrough for electrical networking. Generally, a gangbox is installed within the wall about its back, sides, or both, by means of generally substantially planar fastener holes adapted for receiving fasteners such as, screws, or the like therethrough. As opposed to securing the back of the gangbox within the wall, securing a gangbox about its side, such as, in case of securing the gangbox to a wall stud, is relatively inconvenient as the planar fasteners holes are disposed parallel to the side thereby, making it impossible for tools like an elongated screw driver or the like together with the hands to be received within the gangbox in order to thoroughly secure the fasteners. Due to this, the tools are angled when being worked on the fasteners resulting in the fasteners not being thoroughly received through the fastener holes thereby leaving the gangbox, upon installation, loose and shaky.

In the light of what is discussed, there is a need in the art for a solution for the aforementioned problem.

### SUMMARY

The present invention comprises a rectangular support plate for thoroughly mounting a rectangular electrical gangbox sideways to a vertical frame section of a wall stud wherein, the gangbox comprises a pair of knockouts disposed on a side thereof. The support plate comprises a pair of angled elongate holes that are adapted to align with the pair of knockout holes wherein, a knockout hole, as well known in the art, comprises a hole formed by the removal of a knockout. In order to secure the gangbox to the wall stud, with an outer side of the gangbox abutting the wall stud and the inner side of the gangbox abutting the support plate such that, the pair of elongate holes are aligned with the pair of knockout holes, fasteners are thoroughly driven through the elongate holes whereby, the fasteners engage the wall stud through the knockout holes resulting in the gangbox being mounted to the wall stud. Notably, the elongate holes are angled towards the opening of the gangbox. Notably, the distance between the elongate holes is adjustable so as to accommodate different distances between the knockout holes.

Other objects and advantages of the embodiments herein will become readily apparent from the following detailed description taken in conjunction with the accompanying drawings.

### BRIEF DESCRIPTION OF THE DRAWINGS

FIG. 1, according to an embodiment of the present invention, is an illustration of a perspective view of the support plate.

FIG. 2, according to an embodiment of the present invention, is an illustration of a perspective view of the gangbox.

FIG. 3, according to an embodiment of the present invention, is an illustration of a front view of the support plate.

FIG. 4, according to an embodiment of the present invention, is an illustration of a rear view of the support plate.

FIG. 5, according to an embodiment of the present invention, is an illustration of an exploded perspective view of the support plate.

FIG. 6, according to an embodiment of the present invention, is an illustration of a perspective view of the base plate.

FIG. 7, according to an embodiment of the present invention, is an illustration of a front view of the base plate.

FIG. 8, according to an embodiment of the present invention, is an illustration of a perspective view of a slider member.

FIG. 9, according to an embodiment of the present invention, is an illustration of a front view of a slider member.

FIG. 10, according to an embodiment of the present invention, is an illustration of a rear view of a slider member.

FIG. 11, according to an embodiment of the present invention, is an illustration of a side sectional view of a slider member.

FIG. 12, according to an embodiment of the present invention, is an illustration of a perspective view of the gangbox with the knockout removed.

FIGS. 13A through 13C, according to an additional embodiment of the present invention, are sequential illustrations of gangbox fitted to a wall stud by means of the support plate.

FIG. 14, according to an additional embodiment of the present invention, is an illustration of a perspective view of the support plate.

FIG. 15, according to an additional embodiment of the present invention, is an illustration of a front view of the support plate.

FIG. 16, according to an additional embodiment of the present invention, is an illustration of a rear view of the support plate.

FIG. 17, according to an additional embodiment of the present invention, is an illustration of a side view of the support plate.

FIG. 18, according to an alternate embodiment of the present invention, is an illustration of a perspective view of the support plate.

### FIGURES—REFERENCE NUMERALS

10—Support Plate
12—Electrical Gangbox
14—Knockout
16—Base Plate
18—Slider Member
20—Rectangular Opening
22—Longer Side
24—Shorter Side4
26—Front Plate
28—Mid Plate
30—Fastener Hole
32—Fastener Tube
34—Rear Plate
36—Knockout Hole
38—Wall Stud
40—Knockout Hole
42—Screw

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

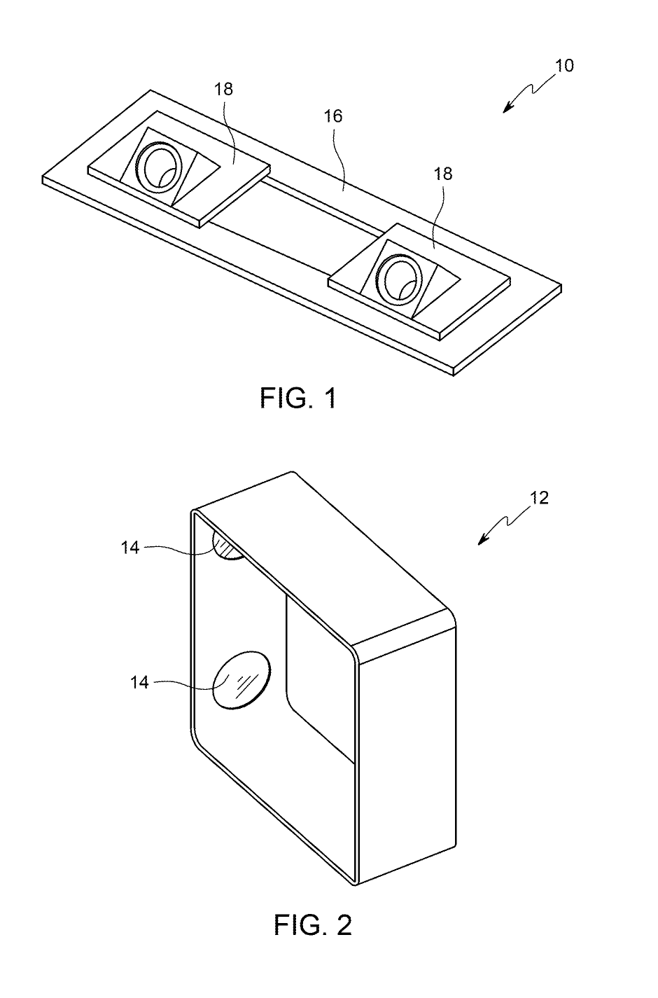

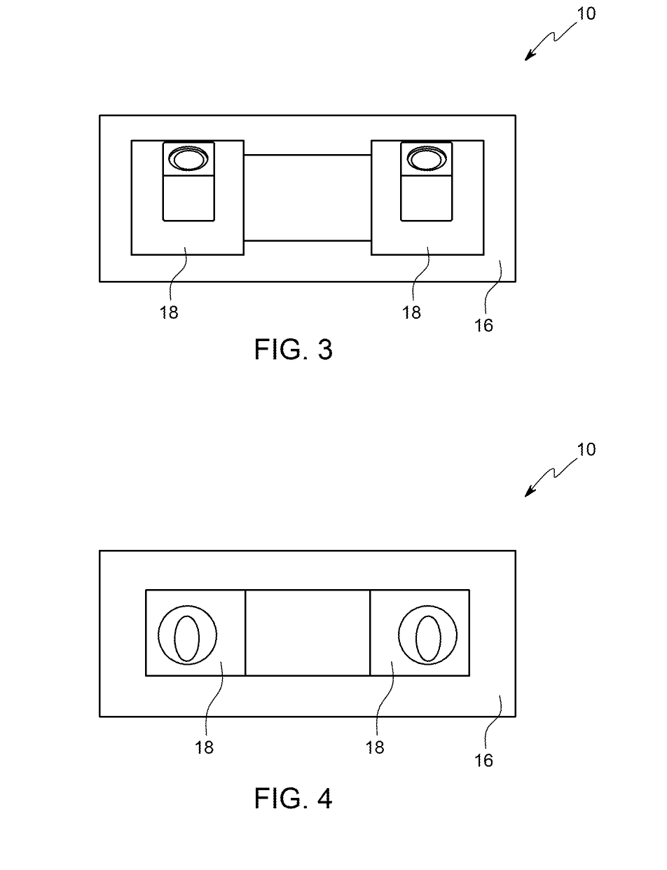

Referring to FIGS. 1 through 5, the present invention comprises a support plate 10 for securing an electrical gangbox 12 sideways to a substrate or a support member, such as a vertical section of a wall stud (not shown). More particularly, as can be appreciated from FIG. 2, the gangbox 12 comprises a pair of top and bottom knockouts 14 wherein, the support plate 10 is adapted to be fastened to the wall stud through the knockouts 14 thereby consequentially mounting the gangbox 12 to the wall stud. Notably, the knockouts 14 could be of standardized diameters of 0.5 inch, 0.75 inch, etc.

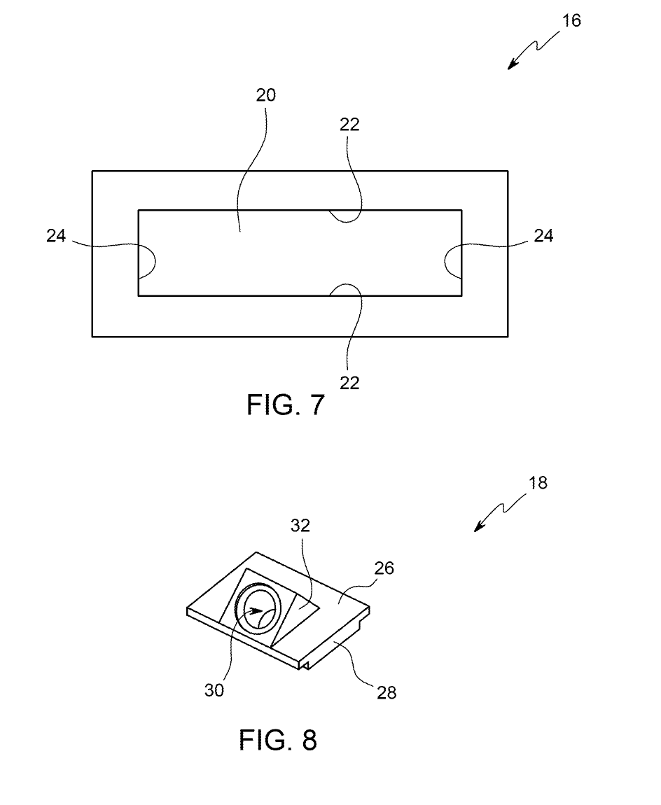

Referring to FIGS. 1, and 3 through 7, the support plate 10, which comprises a rectangular structure, comprises a rectangular base plate 16 and a pair of rectangular slider members 18 slidably mounted to the base plate 16. The base plate 16, which comprises planar front and rear surfaces, comprises a centrally-disposed rectangular opening 20 defined by pairs of opposingly-disposed longer and shorter sides 22 and 24 as seen in FIGS. 6 and 7. Notably, the longer and shorter sides 22 and 24 of the rectangular opening 20 are parallel to the sides of the base plate 16.

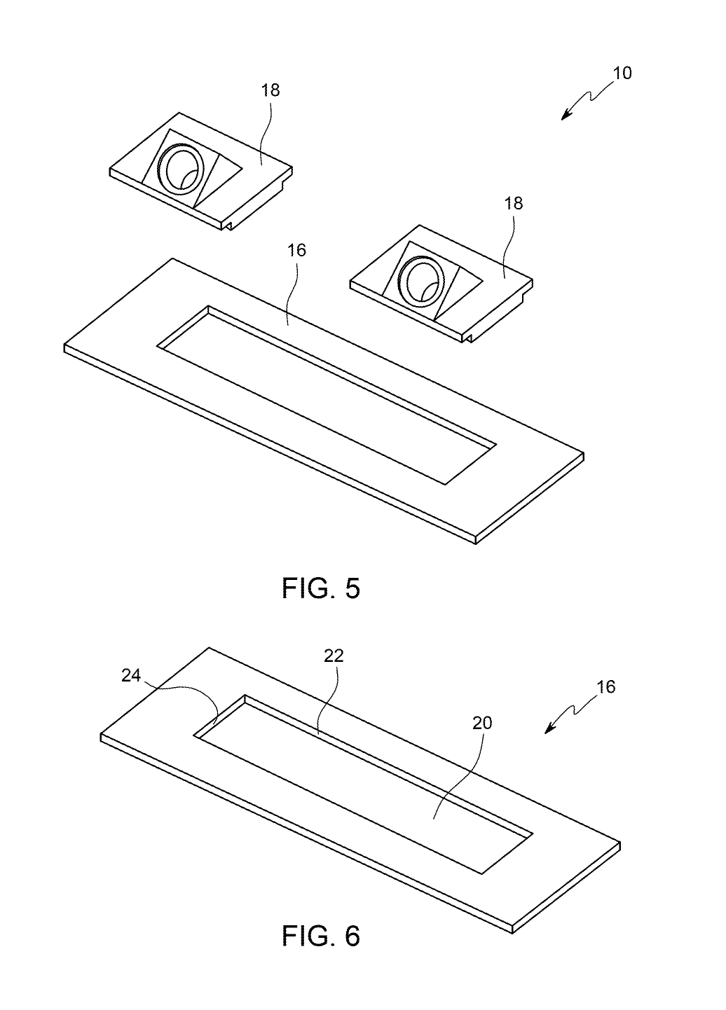

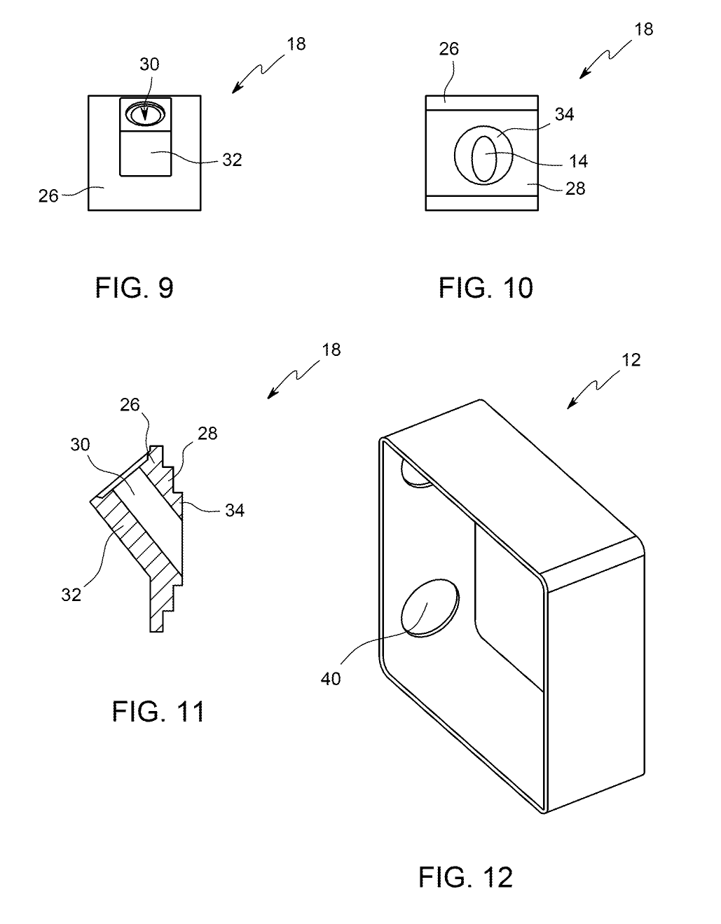

Referring to FIGS. 5, and 8 through 11, a slider member 18 comprises a rectangular front plate 26, the length and width of which being lesser and greater than the rectangular opening 20 respectively wherein, the utility of such dimensional configuration will become apparent from the following body of text. The slider member 18 further comprises a rectangular mid plate 28 extending integrally from the rear surface of the front plate 26 such that, the front and mid plates 26 and 28 parallel to each other and so are the four sides of both the plates 26 and 28. Notably, the width of the mid plate 28 is equivalent to that of the front plate 26. While the length of mid plate 28 is lesser than that of the rectangular opening 20, the width of the mid plate 28 is dimensionally configured such that, the mid plate 28 is snugly and slidably received between the longer sides 22 of the rectangular opening 20. More particularly, while the mid plate 28 is received within the rectangular opening 20, the rear surface of the front plate 26 abuts the front surface of the base plate 16. Therefore, in a way, the rectangular opening 20 serves as a track or a rail for the slider members 18 to slide therewithin.

Still referring to FIGS. 5, and 8 through 11, the slider member 18 further comprises a circular rear plate 34 extending integrally from the rear surface of the mid plate 28. The diameter of the rear plate 34 is adapted to be equivalent to the diameter of the knockouts 14 (FIG. 2), whereby, a rear 34 plate is adapted to be snugly received into a knockout hole (i.e., the hole 40 (FIG. 12) formed by the removal of a knockout 14 (FIG. 2)) as the support plate 10 is coupled to the gangbox 12. In one embodiment, the rear plate 34 is adapted to be snugly received into a knockout hole 40.

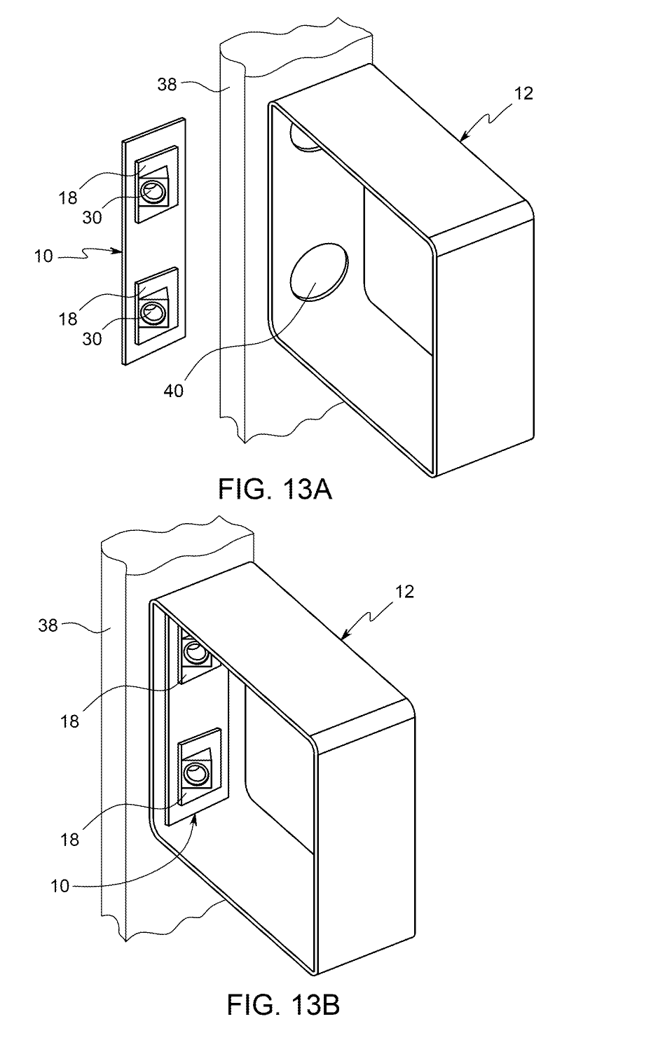

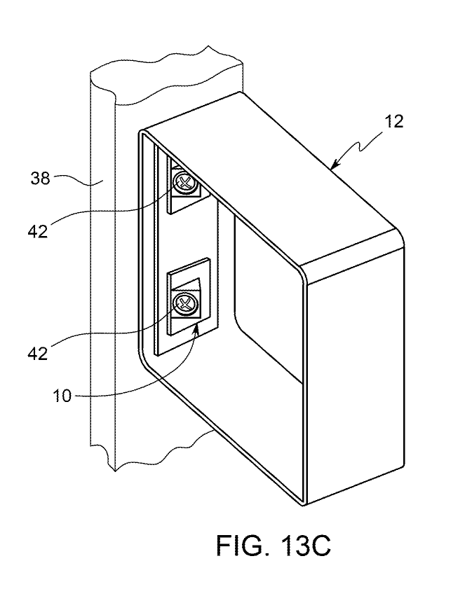

Still yet referring to FIGS. 5, and 8 through 11, the slider member 18 further comprises a fastener hole 30 extending between an ingress and an egress while extending through the front, mid and rear plates 26, 28, and 34. The ingress extends beyond the front surface of the front plate 26 as the slider member 18 further comprises an elongate and obliquely-oriented fastener tube 32 extending integrally and substantially from front surface of the front plate 26. In other words, the free end of the fastener tube 32 serves as the ingress for the fastener (not shown). The outer cross-section of the fastener tube 32 may be rectangular, circular, or of any other suitable cross-sectional shape. The egress terminates at the rear surface of the rear plate 34. Preferably, the egress is sealed by a knockout 14. Notably, the fastener comprises a screw for being threadably received into the fastener tube 32 and, upon being thoroughly received within the fastener tube 32, extending beyond the rear surface of the rear plate 34 so as engage the wall stud 38 (FIGS. 13A through 13C). As mentioned earlier, the rear plate 34 is dimensionally-configured to be snugly received within a knockout hole 40 (FIG. 12). Further, the thickness of the rear plate is configured to be equivalent to the depth of the knockout hole 40 (FIG. 12) so as to eliminate any gap between the support plate 10 and the inner side of the gangbox 12 (FIGS. 2 and 12) as the support plate 10 is mounted to the wall stud 38 (FIGS. 13A through 13C).

Referring to FIGS. 12, and 13A through 13C, in order to mount the gangbox 12 to the wall stud 38, initially the pair of top and bottom knockouts are removed (or knocked out) from the gangbox so as to form a pair of top and bottom knockout holes 40 respectively in lieu thereof.

Thereafter, with the outer side of the gangbox 12 abutting the vertical planar surface of the frame section of the wall stud 38, the distance between the fastener holes 30 and thereby the slider members 18 is adjusted so that, the support plate 10 engages the gangbox 12 as the rear plates (not shown) are received within the knockout holes 40. Alternatively, the support plate 10 may be engaged to gangbox 12 in the aforementioned manner prior to making the gangbox 12 abut the wall stud 38. Notably, prior to the usage of the support plate 10, the knockouts 14 thereof are to be removed or knocked off for obvious reasons. Notably, the support plate 10 is engaged to the gangbox 12 such that, the ingresses are faced towards the front opening of the gangbox 12 for facilitating fastening and removal of the screws that are to be eventually threadably received within the fastener holes 30. Once the position of the gangbox 12 with respect to the wall stud 38 is adjusted, screws 42 are finally thoroughly drilled through the fastener holes 30 whereby, the shank of the screws 42 engage the wall stud 38 through the knockout holes 40 thereby consequentially mounting the side of gangbox 12 to the wall stud 38. As the gangbox 12 mounted to the wall stud 38, the gangbox 12 may also mounted to a horizontal ceiling joist by engaging the support plate 10 to the knockout holes 40 disposed on the upper side of the gangbox 12 and thereafter fastening the support plate 10 to the ceiling joist through the knockout holes 40.

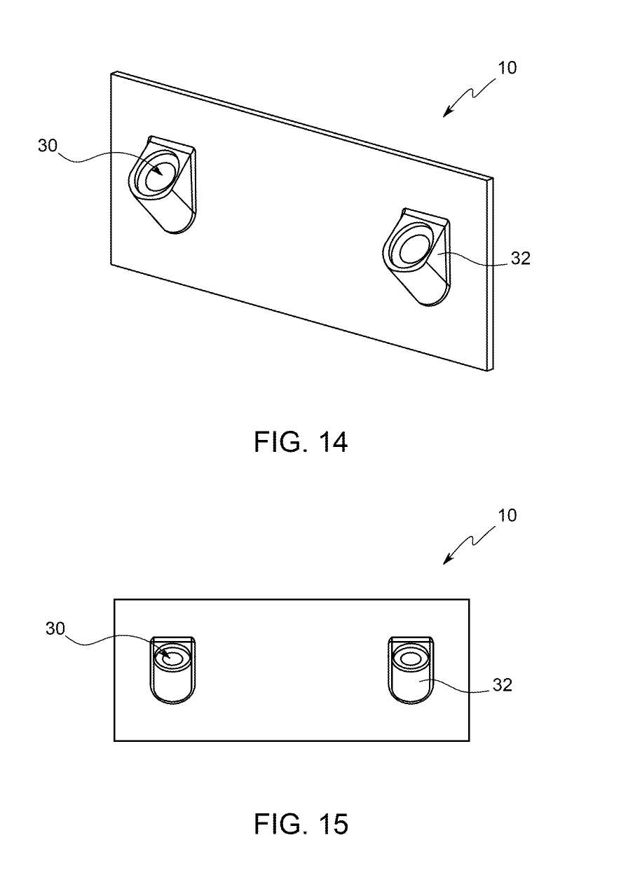

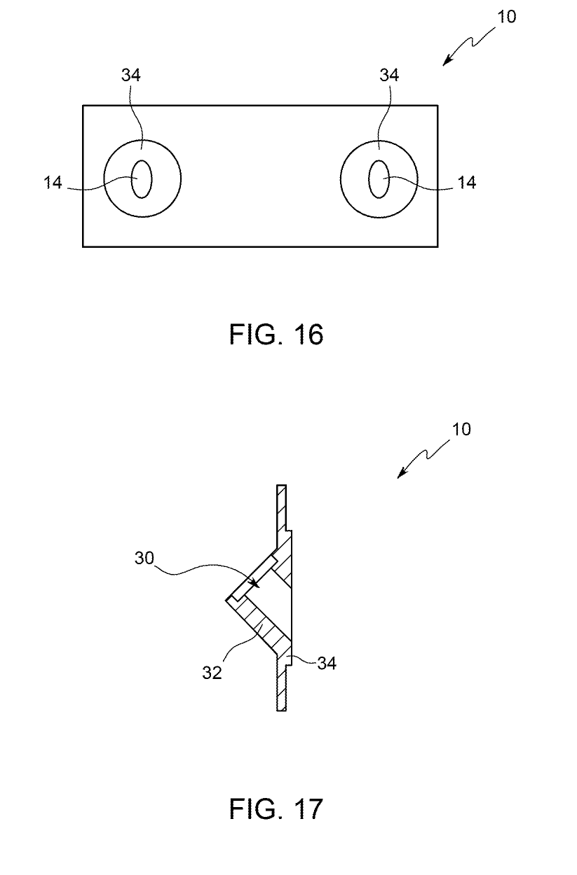

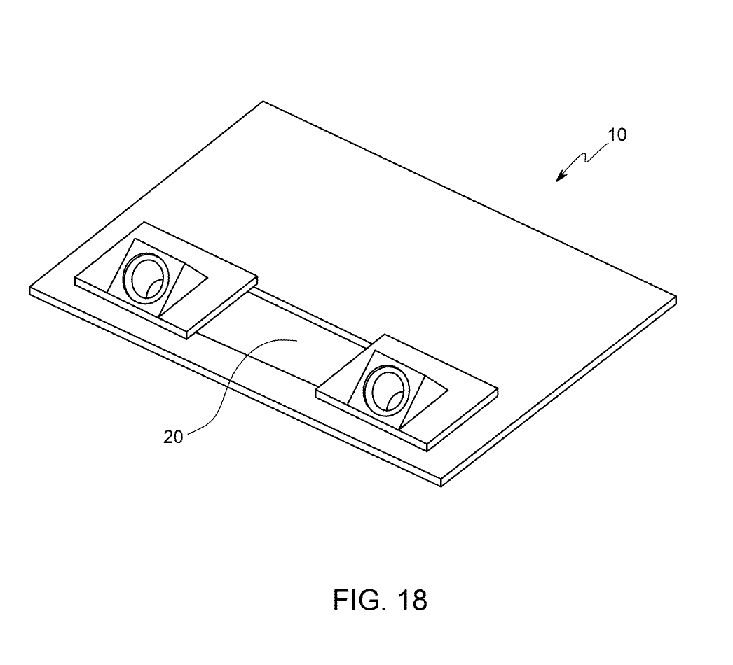

Referring to FIGS. 14 through 17, in one embodiment, the distance between the slider members is fixed. More particularly, in this embodiment, the support plate 10 simply comprises a rectangular plate and a circular rear plate with fastener holes 30 extending therethrough both. As in the earlier embodiment, the fastener tube 32 extends integrally and obliquely from the front surface of the support plate 10 as seen in the referred illustrations. Referring to FIG. 18, in one embodiment, the rectangular opening 20 is not centrally disposed, but disposed towards the edge or side of the support plate 10 that is closer to the front opening of the gangbox. Further, in this embodiment, the width of the support plate 10 is larger so as to enable the mounting of deeper gangboxes to the wall stud.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. For example, the protective case assembly can be adapted to accommodate a tablet PC by simply altering the dimensions thereof. However, all such modifications are deemed to be within the scope of the claims.

What is claimed is:

1. A support plate for mounting a side of an electrical gangbox to a support member, the gangbox comprising at least one circular knockout disposed on a side thereof, the support plate comprising at least one fastener hole, each of which adapted to receive a fastener therethrough wherein, upon the rear surface of the support plate being engaged with the inner side surface of the gangbox such that, the egress or egresses of the at least one fastener hole is disposed to be within the areal purview of the at least one knockout hole, a fastener thoroughly received within a fastener hole is engages the support member through a knockout hole, a knockout hole comprising the hole formed in lieu of a knockout by the removal of the knockout.

2. The support plate of claim 1 wherein, the support member comprises a vertical segment of a wall stud.

3. The support plate of claim 1 wherein, the support member comprises a horizontal segment of a wall stud.

4. The support plate of claim 1 wherein, the support member comprises a horizontal ceiling joist.

5. The support plate of claim 1 wherein, the fastener comprises a screw.

6. The support plate of claim 1 wherein, the fastener hole is elongated.

7. The support plate of claim 6 wherein, the fastener hole is angled with respect to the support plate.

8. The support plate of claim 7 wherein, the angle between fastener hole and the support plate is 45 degrees.

9. The support plate of claim 7 wherein, the angle between fastener hole and the support plate is 55 degrees.

10. The support plate of claim 1 being rectangular.

11. The support plate of claim 1 wherein, the ingress of the fastener hole is angled towards the front opening of the gangbox.

12. The support plate of claim 1 wherein, the at least one fastener hole comprises a pair of fasteners holes.

13. The support plate of claim 12 wherein, the distance between the fastener holes is adjustable.

14. The support plate of claim 13 further comprises:
(a) a base plate comprising a central rectangular opening comprising a pair of opposingly-disposed longer sides; and
(b) a pair of slider members coupled to the base plate such that, each slider member is slidable within the rectangular opening, each slider member comprising a fastener hole disposed thereon.

15. The support plate of claim 14 wherein, a slider member comprises:
(a) a rectangular front plate being laterally wider than the distance between the pair of longer sides;
(b) a rectangular mid plate extending centrally and integrally from the rear surface of the front plate so as to form a stepped configuration, the mid plate adapted to be snugly received within the rectangular opening whereby, a pair of opposite edges of abut the pair of longer sides so as to enable sliding within the rectangular opening; and
(c) a circular rear plate extending integrally from the rear surface of the mid plate so as to form a stepped configuration, the rear plate adapted to be received within a knockout hole; the fastener hole extending through the front, mid and rear plates.

16. The support plate of claim 15 wherein, the rear plate is adapted to be snugly-fitted into a knockout.

17. The support plate of claim 16 wherein, the knockout is 0.5 inch in diameter.

18. The support plate of claim 16 wherein, the knockout is 0.75 inch in diameter.

19. The support plate of claim 15 wherein, the rear plate is adapted to be snap-fitted into a knockout.

20. The support plate of claim 1 wherein, the egress of each of the at least one fastener hole is sealed by a knockout.

21. The support plate of claim 1 wherein, the at least one knockout comprises a pair of knockouts.

22. A support plate for mounting a side of an electrical gangbox to a support member, the gangbox comprising a pair of circular knockouts disposed on a side thereof, the support plate comprising a pair of elongate fastener holes, each of which adapted to receive a fastener therethrough wherein, upon the rear surface of the support plate being brought into contact with the inner side surface of the gangbox such that, the egresses of the fastener holes are disposed to be within the areal purview of the knockout holes, a fastener thoroughly received within a fastener hole is adapted to engage the support member through a knockout hole, a knockout hole comprising the hole formed by the removal of a knockout, each fastener hole being obliquely oriented with respect to the support plate, the distance between the fasteners holes being adjustable.
